(19) United States
(12) Patent Application Publication
(10) Pub. No.: US 2020/0140191 A1
(43) Pub. Date: May 7, 2020

(54) Flat Yard Trash Wrap

(71) Applicant: Sami Fanek, Langwood, FL (US)

(72) Inventor: Sami Fanek, Langwood, FL (US)

(21) Appl. No.: 16/179,969

(22) Filed: Nov. 4, 2018

(51) Int. Cl. B65F 1/00

(52) U.S. Cl. CPC B65F 1/0006; B65F 2250/114; B65F 2240/138

(57) ABSTRACT

This invention represents a new way to bag yard trash. The yard trash Wrap is a more efficient way bundle larger sticks and tree limbs. The Yard trash wrap is a large heavy duty plastic sheet with four handles. It is placed flat on the ground, sticks and tree limbs are stacked in the Center area until the pile is large enough. Tie together the two handles On the right with the two handles on the left and the trash is bundled And ready to go to the curb.

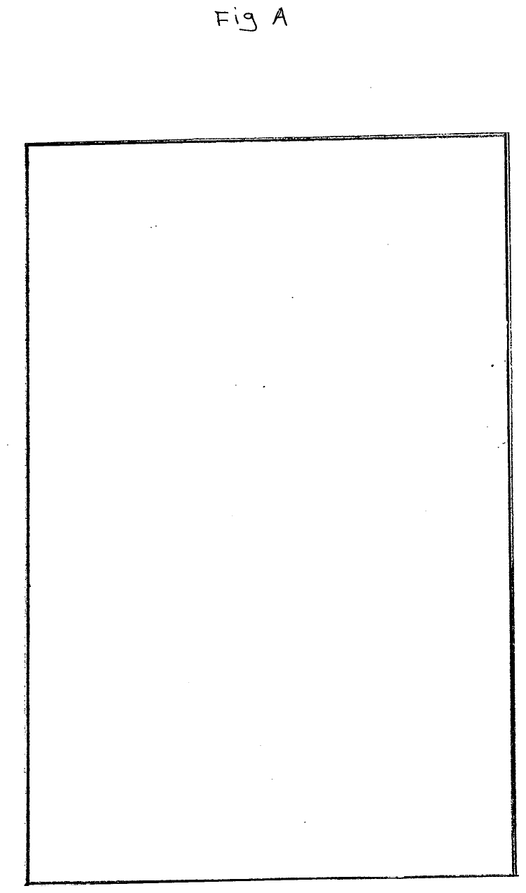

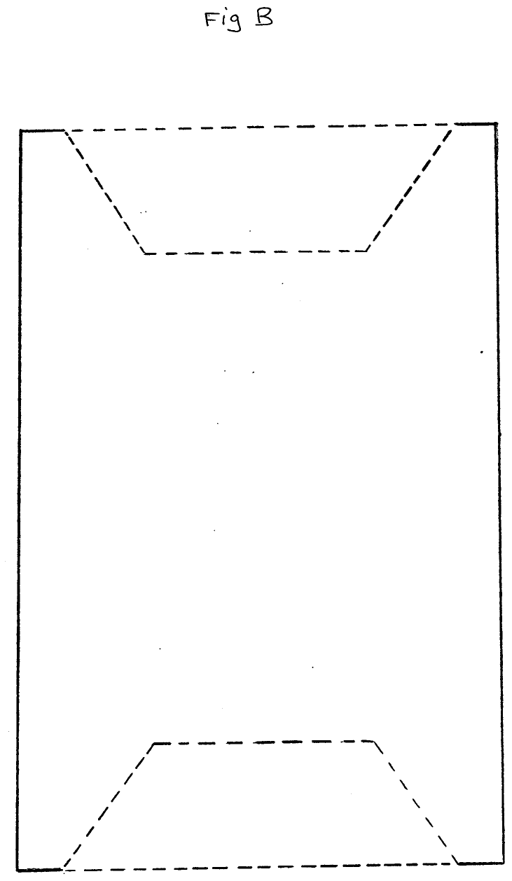

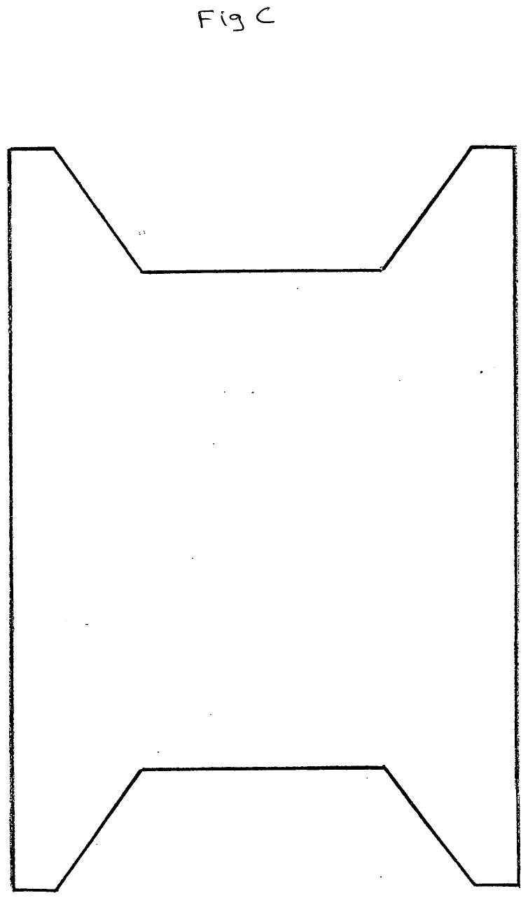

### BACKGROUND OF INVENTION

This invention represents an alternative way to bag yard trash, such as sticks and tree limbs. Currently, on the market one can purchase several varieties of yard trash bags. What they all have in common is that they are bags, which makes it difficult to squeeze large sticks and tree limbs into the bags without tearing or ripping them apart. In most parts of the USA yards trash will not be picked up unless it is bundled or bagged. The main objective with our flat yard trash wrap is the fact that it is not a bag but a flat plastic wrap that is placed flat on the ground. A single plastic flat wrap with four handles which are integrated into the wrap made from the same plastic material. One handle on each corner of the wrap which can then be used to tie together the bundles of yard trash. With this style the handles on the corners is the same plastic material as the wrap. The yard trash wrap can be placed flat on the ground. The sticks and tree limbs are then piled in the center area of the wrap. Once the pile is large enough simple grab the two handles on the right and tie them together with the two handles on the left creating a secure bundle which can easily be carried to the curb. This task can be accomplished without having to shove, and poke large sticks into a traditional trash bag.

### SUMMARY OF INVENTION

This invention will replace a typical yard trash bag that is used for sticks and tree limbs. Our flat yard trash wrap is a heavy duty plastic sheet with four handles. The plastic sheet is placed flat on the floor and the tree sticks and limbs can be piled up on the sheet. Once the pile is complete simply tie together the handles on the right side and the handles on left side to bundle and secure it tightly. This new trash wrap will eliminate having to push stick and limbs into a bag and then poking holes and ripping the old fashion kind of trash bag.

### DETAILED DESCRIPTION OF INVENTION

This invention is a large flat plastic yard trash wrap with four handles. Problem—existing yard trash bags are difficult to use when bagging larger pieces of brush, sticks, and tree limbs and shrubberies. These larger pieces of yard trash often poke holes in the existing bags making the bagging process frustrating and unproductive because you have to break the sticks and shrubberies into small pieces to fit them into the bag. Our plastic flat yard trash wrap will solve this problem of having to break tree limbs and sticks small enough to fit inside a traditional trash The flat plastic wrap can be placed flat on the floor and the shrubberies, limbs, and sticks will pile onto the wrap. Once all yard trash is placed on the wrap simple tie together the two handles on right side and the two handles on the left side. No longer having to force a lager stick into a bag. A large plastic flat yard wrap with four integrated handles, one on each corner of the wrap. The handles are of the same plastic material.

### DRAWING DESCRIPTION

FIG. A represents a rectangular typical high or low density polyethylene trash sheet. This sheet is made out of same material as any typical yard trash bag that is currently available on the market. Instead of it being a bag it is a sheet.

FIG. B represents the same high or low density polyethylene yard trash sheet as pictures in FIG. A. with the addition of perforated lines. These perforated lines indicate where the yard trash sheet will be cut to shape.

FIG. C represents the same high or low density polyethylene sheet as in FIG. A with the perforated lines illustrated in Fig B already cut out.

FIG. C represents the final shape of the flat yard trash wrap with the four handles so that it can be placed flat on the ground and the yard trash can be piled in the center of the wrap. Once the pile is centered the two handles on the right and the two handles on left can be tied together to secure the pile. The flat yard trash wrap will come in various sizes.

1. The yard trash wrap provides a quicker, easier, more productive way of bundling yard trash such as large sticks shrubberies and tree limbs. The Yard trash wrap is a single piece of heavy duty plastic sheet with four Handles, one on each corner. The yard trash wrap is simply placed Fiat on the ground. The sticks and tree limbs are stacked in the center Area of the yard trash wrap. Once the pile is large enough, tie together The four handles and your bundle is ready to be carried to the curb for Pick up. Existing yard trash bags present the dilemma of trying to. Squeeze the large sticks and tree limbs into a bag, often resulting with ripped and tom trash bags that fall apart.
